(19) United States
(12) Patent Application Publication
(10) Pub. No.: US 2005/0120352 A1
(43) Pub. Date: Jun. 2, 2005

(54) Meta directory server providing users the ability to customize work-flows

(75) Inventor: Subhashini Subramaniam, Bangalore (IN)

Correspondence Address: NARENDRA R. THAPPETA, LANDON & STARK ASSOCIATES, ONE CRYSTAL PARK, SUITE 210, 2011 CRYSTAL DRIVE, ARLINGTON, VA, 22202, US

(73) Assignee: Sun Microsystems, Inc., Santa Clara, CA (US)

(21) Appl. No.: 10/722,408

(22) Filed: Nov. 28, 2003

(51) Int. Cl. G06F 3/00

(52) U.S. Cl. 719/310

(57) ABSTRACT

A meta directory server which permits an administrator to specify extension points at potentially any point of a work flow, and associate a custom task with each extension point. The custom task is executed when the associated extension point is reached during execution. Due to such a feature, the administrator may customize a work to a desired extent. According to another aspect of the present invention, the custom tasks may be executed synchronously or asynchronously.

### BACKGROUND OF THE INVENTION

1. Field of the Invention

The present invention relates to meta directory servers used in conjunction with databases, and more specifically to a method and apparatus for providing users the ability to customize work-flows.

2. Related Art

Meta directory servers are often used in conjunction with data sources (e.g., database, LDAP based directory server, ERP systems) to perform operations such as synchronization and consolidation. As is well known, synchronization generally refers to propagation of a change (including addition, deletion, modification) in one data source to another data source. Consolidation generally refers to providing a unified integrated view of different pieces of data (about the same entity, e.g., an employee) present at different data sources.

For example, a meta directory server may be configured to specify that a change in a first database is to be propagated to a second database based on a common key, and the meta directory server then generally ensures that changes in the first database are propagated to the second database. Similarly, a meta directory server be configured to indicate that a third database is to be created from two relational databases having at least one non-common column, and a union of the columns in the two relational databases is performed to create the third database (for the consolidation operation).

Meta directory servers often provide the infra-structure to execute work-flows, which can be easily applied with reference to various data sources as desired by an administrator. In general, a work-flow contains a set of tasks (“built-in tasks”), which when executed (in relation to data sources specified by the administrator) would perform a corresponding operation. For example, with respect to synchronization, an administrator may merely need to specify two databases and a common key, and the meta directory may execute various pre-defined built-in tasks to automatically synchronize the two databases using the common key. An administrator may similarly implement consolidation by providing fairly minimal information to a meta directory server.

Administrators of meta directory servers often prefer the ability to customize various work-flows. For example, an administrator may wish to execute custom tasks (e.g., to ignore certain types of changes or to handle exception conditions such as a row/record not being found) on occurrence of a specific condition in the middle of execution of a built-in task. Similarly, an administrator may wish to execute a sequence of custom tasks upon the occurrence of a corresponding sequence of conditions.

### BRIEF SUMMARY

An aspect of the present invention enables a user to customize a work flow associated with an operation (e.g., synchronization or consolidation of two data sources) in a meta directory server. In an embodiment, multiple built-in tasks are provided to implement the operation, with at least one built-in task containing an extension point. Data indicating a custom task associated with the extension point is received, and the custom task is executed upon reaching the extension point during execution of the one of the multiple built-in tasks.

In one embodiment, the built-in tasks are provided by a designer implementing a meta directory server, and user using the meta directory server is provided the flexibility to implement the custom tasks. The designer may provide extension points at all possible points of interest to the user, and the user may then implement extension points as desired. As a result, each user of a meta directory server may be provided the ability to customize work-flow in a desired manner.

According to another aspect of the present invention, custom tasks may also contain extension points, with the user being provided the ability to indicate corresponding custom tasks. As a result, a sequence of custom tasks may be implemented depending on various scenarios encountered during the execution of tasks supporting work-flows.

Another aspect of the present invention provides a convenient user interface using which work-flows can be customized. Each task may be implemented to support a utility (e.g., a Java-method) which determines the extension points available in each built-in task. The determined extension points may be displayed associated with a corresponding task. The available custom tasks may also be displayed to enable the user to associate custom tasks with corresponding extension points, as desired.

One more aspect of the present invention enables each custom task to be executed either synchronously (i.e., the execution of a first task initiating a second task is suspended until the execution of the second task is complete) or asynchronously (i.e., the initiating and initiated tasks executing in parallel) as specified by the user.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings, wherein:

FIG. (FIG.) 1 is a block diagram illustrating an example environment in which the present invention can be implemented.

FIG. 2 is a flowchart illustrating the desired customization of a work-flow in an example scenario.

FIG. 3 is a flowchart illustrating a method in which a meta directory server enables a user to customize the work-flows in an embodiment of the present invention.

FIG. 4 is a block diagram illustrating the manner in which the tasks may be executed in synchronous or asynchronous mode according to an aspect of the present invention.

FIG. 5 is a block diagram illustrating the details of an example embodiment of a meta directory server.

FIG. 6 is a sequence diagram depicting the control flow in the meta directory server in an embodiment of the present invention.

FIG. 7 contains a set of program interfaces which may need to be implemented in a task in an embodiment of the present invention.

FIG. 8 contains a set of program interfaces which may be required for custom tasks to access other components of a meta directory server in an embodiment of the present invention.

FIG. 9 contains a screen illustrating an example user interface using which a user may customize a work-flow in an embodiment of the present invention.

FIG. 10 is a block diagram illustrating the details of implementation of a meta directory server substantially in the form of software.

### DETAILED DESCRIPTION

1. Overview

A meta directory server provides a user the ability to customize work-flows according to an aspect of the present invention. In an embodiment, a user may specify extension points anywhere in the middle of a task, and custom tasks associated with the respective extension points. The meta directory server then executes the custom task when the associated extension point is reached. As a result, the ability to customize work-flows may be substantially enhanced.

A meta directory server according to another aspect of the present invention enables custom tasks to be executed asynchronously, i.e., execution of both the built-in task and custom task can continue in parallel. Such a feature may be useful, for example, to monitor various transactions (e.g., update requests received/pending) and generate graphs/reports using custom tasks, while the built-in tasks continue to perform the transactions.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Example Environment

FIG. 1 is a block diagram illustrating the details of an example environment in which the present invention can be implemented. The environment is shown containing database servers 110, 120, and 130 and meta directory server 150. Each system/server is described below in further detail.

Database servers 110, 120 and 130 generally represent data sources, which enable users to store/retrieve data. Meta directory server 150 enables operations such as consolidation and synchronization of various data sources. Various aspects of the present invention enable the work-flows implementing such operations to be customized as described below in further detail. First, it is helpful to understand an example work-flow and the manner in which a user may wish to customize the work-flow.

3. Example Work-flow

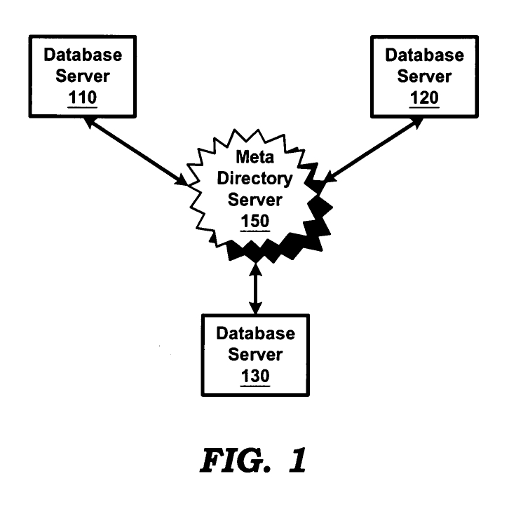

FIG. 2 is a flow chart illustrating the details of a work-flow implementing consolidation operation and also the manner in which a user may wish to customize the work-flow. The flow chart is shown containing steps 210-250 implementing built-in tasks, and steps 260, 270, 280 and 290 implementing custom tasks. Broadly, the built-in tasks implement consolidation operation, and custom tasks provide the desired customization. The built-in tasks and custom tasks are described below in further detail.

For illustration, it is assumed that meta directory server 150 is to consolidate data bases in database servers 110 and 120 to generate a consolidated view in database server 130. The work-flow begins in step 201, in which control immediately passes to step 210.

In step 210, meta directory server 150 receives a change from a data source (e.g., database server 110), for example, by executing a built-in task (or a portion thereof). The built-in task may poll database server 110 to determine the presence of the change, and retrieve the corresponding data (e.g., a row in the case of a relational database). Alternatively, a message packet indicating the change may be received automatically without polling for the change.

In step 215, the received change is passed to a module(s) (in meta directory server 150) performing consolidation logic. The change may be passed in one of several ways, as is suitable within the architectural framework of meta directory server 150. In step 220, a determination is made as to whether additional data is required to process the change. Consolidation operation generally requires additional data from other data source(s) before generating a record for storing the consolidated view. Configuration data within meta directory server 150 may be examined to determine whether additional data is required.

Control is transferred to step 235 if additional data is not required, or else control is transferred to step 225. In step 225, the required data is collected by retrieving the corresponding data consistent with the interface provided by the data source. In general, the required data is determined by examining configuration data specifying the rules of the consolidation operation and the synchronization operation.

In step 230, a determination is made as to whether the complete data is collected in step 225. If complete data is not collected, control is transferred back to step 225 to collect more data, else control is transferred to step 235. As may be appreciated, the loop of steps 225 and 230 is continued until all the necessary data is collected from the appropriate data sources.

In step 235, transformations are performed on the received/retrieved data if needed. For example, if the received data contains first name and last name fields and database server 130 maintains a complete name field, then a transformation is performed to concatenate both the fields to generate a complete name. In step 240, the consolidated data from step 235 is sent to database server 130 and the consolidated data is stored in database server 130 in step 250. The work-flow ends in step 299.

Thus steps 210-250 described above implement consolidation operation. However, it may be required to customize the tasks performed in the operation. For example, it may be required to abort the consolidation operation based on data validations (e.g., if social security number is not in the required format) for the received change in data. By invoking custom task 260 after executing step 210, the consolidation operation may be aborted by ignoring the change if data validations fail.

In another case, if the required data to be collected (in step 225) is not available in any data source, then it may be desirable to create the data (instead of aborting the consolidation operation). By invoking custom task 270 after built-in task 225, the required data may be created. For example, if the email id of an employee is not available in both database servers 110 and 120, custom task 270 may be designed to create the email id as firstname.lastname@xxx.com (wherein ‘xxx.com’ represents the domain name).

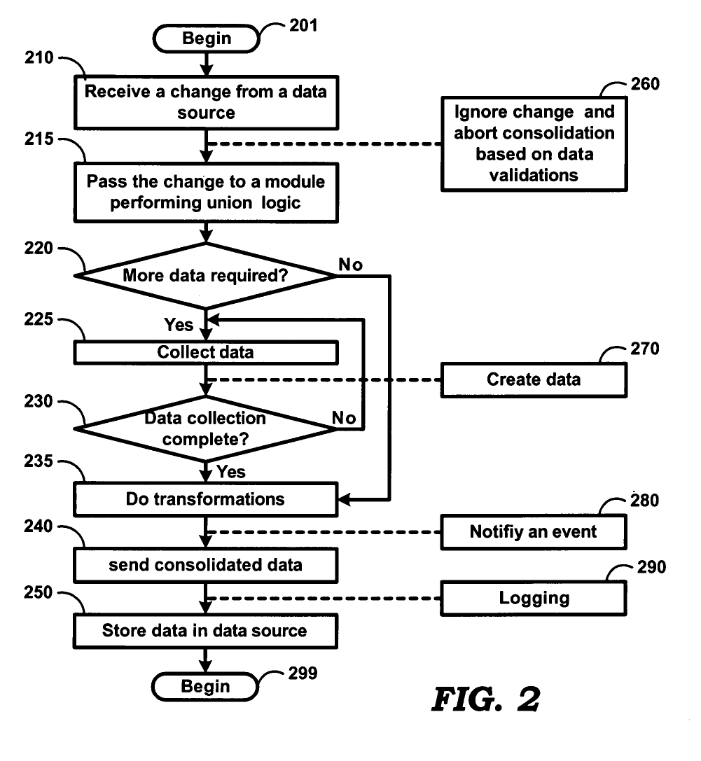

Similarly, custom tasks 280 and 290 may be designed to perform event notification and logging after execution of built-in tasks 235 and 240 respectively. Custom task 280 notifies an administrator (or other applications) the result of the consolidation operation. Custom task 290 may maintain a log of all consolidation operations based on specific criteria of the administrator. Therefore, it may be required at least in some situations to provide customization at many intermediate points in the work-flow. The manner in which the customization may be implemented is described below with reference to FIG. 3.

4. Method

FIG. 3 is a flow-chart illustrating a method using which a meta directory server enables a user (or administrator) to customize the work-flows in an embodiment of the present invention. The method is described with reference to FIGS. 1 and 2 for illustration. However, the method may be implemented in other environments and other type of operations as well. The method begins in step 301, in which control immediately passes to step 310.

In step 310, data is received indicating the custom tasks available, the extension points available in both the built-in tasks and custom tasks, and the task to be executed on reaching each extension point. In general, an extension point indicates that the task being executed has reached a corresponding specific state (e.g., determined the absence of first name required to produce a consolidated record).

In one embodiment, a developer of meta directory server 150 provides extension points at various potential points of interest (to users of meta directory server 150), and a user may specify a custom task associated with each extension point. The extension points may be included anywhere in the program code implementing the task such that a desired level of customization of a work flow can be easily implemented by administrators/users. Both the built-in and custom tasks may contain extension point(s), upon the reaching of which the corresponding custom task is executed.

In step 315, the present task is set to equal the first task in the work-flow (e.g., a task executing step 210 of FIG. 2). In step 320, the execution of the present task is continued. In step 330, a determination is made as to whether any extension point is reached in the middle of execution of the present task. Control is transferred to step 340 if an extension point is reached, otherwise to step 370.

In step 340, a custom task specified associated with the extension point (determined in step 330) is executed. The data received in step 310 generally indicates the custom task to be executed. In step 350, while executing the custom task, a determination is made as to whether any extension point is reached in the custom task. If an extension point is reached in the custom task, control is transferred to step 340, else control is transferred to step 320. Thus, the loop of steps 340 and 350 may be performed to execute a sequence of custom tasks.

In step 370, a determination is made as to whether any tasks are remaining in the work-flow. If tasks are remaining, the present task is equal to the next task in step 380, and control passes to step 320. If no tasks are remaining, the method ends in step 399.

From the above, it may be appreciated an extension points may be present any where in a custom (and also built-in) task, and a sequence of custom tasks may be executed in response. In addition, the execution of the built-in task continues after the completion of performance of the custom tasks associated with the extension point. Such an execution is referred to as a synchronous execution. An aspect of the present invention enables custom tasks to be executed in parallel (asynchronously) to the execution of the sequence of custom tasks as described below in further detail.

5. Synchronous vs. Asynchronous Execution

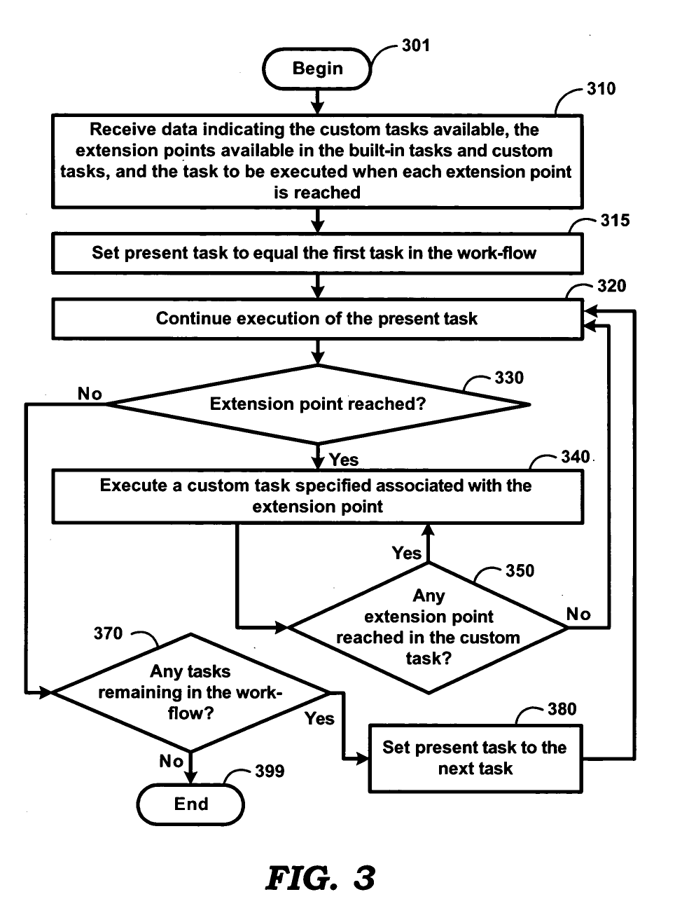

FIG. 4 is a block diagram illustrating the manner in which custom tasks can be executed in either synchronous or asynchronous modes according to an aspect of the present invention. The block diagram is shown containing built-in tasks 410, 420, 430, 440 and 450, custom synchronous tasks (CS task) 480, 485 and 490, and custom asynchronous tasks (CA task) 460, 465, and 470. The built-in tasks generally implement the work flow, and the custom tasks enable the work flow to be customized. Synchronous and asynchronous execution are described in further detail below.

With respect to synchronous mode, the execution of a task is suspended upon invoking a custom task, and execution of the suspended task resumes once the execution of the custom task has completed. For example, built-in task 420 is shown reaching an extension point and execution of the corresponding custom task CS task 480 starts. The execution of built-in task 420 is suspended while CS task 480 is executed. The execution of built-in task 420 is resumed after execution of CS task 480 is complete. Similarly, custom tasks 485 and 490 are also synchronously executed corresponding to the respective extension points in built-in tasks 420 and 450.

With respect to asynchronous mode, the execution of a task continues even if the task invokes a custom mask. For example, built-in task 410 is shown reaching an extension point and the corresponding custom task to be executed is shown as CA task 460. Execution of both CA task 460 and built-in task 410 continues in parallel. It may be observed that CA task 465 in invoked by CA task 460 and CA task 470 is invoked by CA task 465. Therefore, custom tasks 460, 465 and 470 are said to be executed asynchronously in relation to built-in task 410 (i.e. in parallel to built-in tasks 410-450).

The description is continued with reference to an example embodiment implementing the approach of above.

6. Meta Directory Server

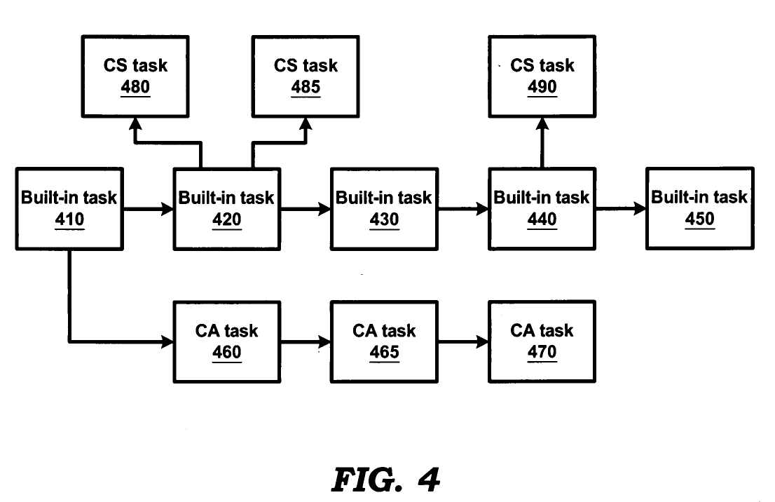

FIG. 5 is a block diagram illustrating the details of an example embodiment of meta directory server 150. Meta directory server 150 is shown containing task registry block 510, user interface module 530, work-flow manager 540, custom task module 550, built-in task module 560, core meta module 570, message bus interface 580 and task application programming interface (API) 590. Each component/system is described below in further detail.

User interface module 530 enables a user to indicate various custom tasks available, and registers/stores the corresponding information in task registry block 510. In addition, user interface module 530 may determine the various extension points available in each task, and permit a user to customize work flows by associating custom tasks with corresponding extension points as desired by a user. An example interface provided to a user is described in a section below.

Task registry block 510 contains the details of various tasks and the extension points contained within each task. In an embodiment, all built-in tasks are provided entries in task registry when the corresponding work-flow is implemented (and the components registered) in meta directory server 150. However, entries corresponding to custom tasks are created as the user defines the custom tasks. Task registry block 510 may contain a convenient mechanism (e.g., based on random variables or sequential allocation) to allocate unique extension point identifiers and task identifiers.

Thus, each entry for a task contains a unique task identifier, a name, a type (whether a built-in task or a custom task) and a record associated with each extension point provided by the task. Each record in turn may contain an extension identifier and a task identifier, with the task identifier specifying the specific task to be executed corresponding to the extension point. For each tasks, the records may contain a field which indicates whether the custom task is to be executed in asynchronous mode or synchronous mode.

Custom task module 550 and built-in task module 560 respectively contain the software code corresponding to custom tasks and built-in tasks to be executed. As may be appreciated, the built-in tasks contain the program logic to implement operations such as consolidation and synchronization. Message bus interface 580 provides an interface to a publishing medium on which various data messages are published, and the published messages may be accessed by data sources. Custom task module 550 may access messages on message bus through task API 590 and built-in task module 560 may access messages directly from the message bus.

Core meta module 570 generally contains built-in task module 560, but the two modules are shown as separate for clarity. Core-meta module 570 contains various sub-modules such as adapters, managing configuration data, etc. Adapters generally contain the logic to communicate with corresponding data sources and perform tasks such as polling for changes and storage/retrieval of records from the underlying data source, as necessary depending on the implementation of the data source.

The configuration data may contain details such as data type definitions (e.g., column names, types, in case of relational databases), relationships (e.g., entity relationships between data sources, keys used in join/synchronization operations for databases), join specifications (e.g., consolidation rule such as concatenate first name and last name to generate complete name), component registry (e.g., adapters list, database specific parameters), etc.

Task API 590 may provide a set of Java-methods (or other form of utilities, which provide similar interface) which can be used by a user to create custom tasks. The provided interface may ensure that custom tasks have limited access to core meta module 570 and message bus interface 580, which may be desirable for several reasons such as preventing users from hampering the work-flows, for security reasons, etc.

Work-flow manager 540 controls the order of execution of all tasks based on information present in task registry block 510. In addition, work-flow manager 540 receives an extension identifier when executing a task, and determines the custom task to be executed by accessing task registry block 510 based on the extension identifier and the identifier of the task generating the extension identifier. The determined custom task is then executed either in asynchronous mode or synchronous mode, as specified by task registry block 510.

In an embodiment, assuming a first task (either custom or built-in) contains an extension point causing a second task (generally custom) to be executed in synchronous mode, the first task may go to a sleep state when the extension point (and notification thereof to work-flow manager 540) is reached. Work-flow manager 540 may then send an interrupt after completion of execution of the second task to cause resumption of execution of the first task.

The operation and implementation of work-flow manager 540 in various embodiments will be further clearer from the description provided below. A sequence diagram illustrating the manner in which custom tasks can be executed synchronously is described first. Some of the interfaces that may need to be provided in to work-flow manager 540 and the custom tasks are described then.

7. Sequence Diagram

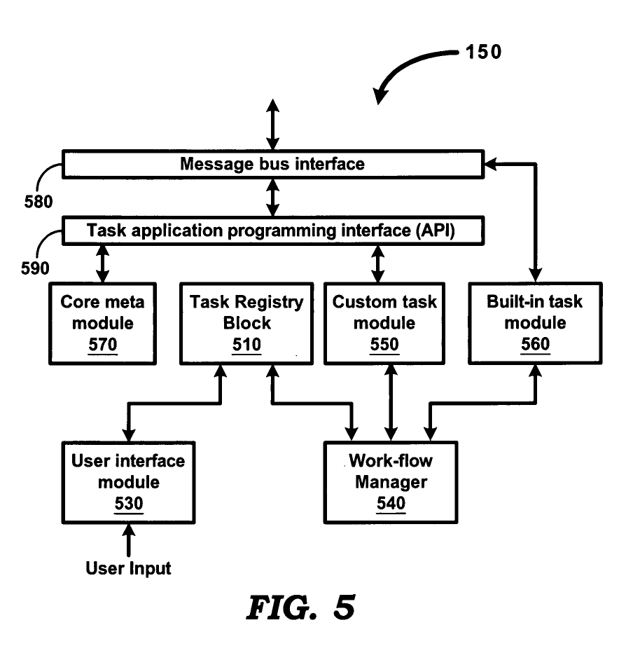

FIG. 6 is a sequence diagram depicting the control flow in a meta directory server in an embodiment of the present invention. The sequence diagram illustrates the control flow for executing two steps (built-in task 210 and custom task 260) of FIG. 2. However, all other built-in tasks and custom tasks may also be executed in a similar manner. As will be appreciated from the below description, 601, 602, 605, 610, 615 relates to initial execution of a built-in task, 630, 640, 650, 660, 670 and 675 relates to execution of a custom task in synchronous mode, and 680 relates to resumption of execution of the built-in task after completion of execution of custom task.

Work-flow manager 540 may access task registry block 510 to determine various task related data (e.g., task identifier, type, etc.) as shown by 601. Work-flow manager 540 then interfaces with built-in task module 560 to execute the corresponding built-in task (assumed to be built-in task 210 of FIG. 2) and is shown by 602. During execution, built-in task 210 may publish various messages on message bus interface 580 as shown by 605.

An extension point is assumed to be reached (while executing built-in task) as shown by 615, and the corresponding extension identifier is passed to work-flow manager 540 as shown by 610. Work-flow manager 540 accesses task registry block 510, as shown by 630, to determine the custom task corresponding to the extension identifier. Work-flow manager 540 then interfaces with custom task module 550 to execute the corresponding custom task (assumed to be 260) as shown by 640.

In addition, work-flow manager 540 suspends built-in task 210 as shown by 650. Custom task 260 publishes various messages on message bus interface 580 using task API 590 during execution as shown by 660 and 670. After executing task 260, custom task module 550 hands over control to work-flow manager 540 (as shown by 675), which then resumes execution of built-in task 210 as shown by 680.

Thus, various tasks can be executed as describe above, which enables a user to customize a work-flow to a desired degree. To coordinate such execution, various interfaces may be desirable. Some features of such interfaces are described below in further detail.

8. Program Interfaces

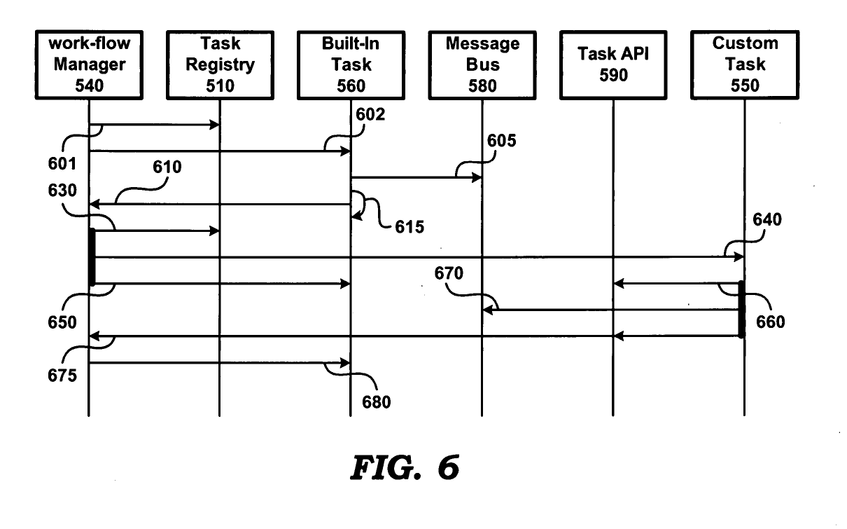

FIG. 7 contains a set of definitions (in Java(™) Programming Language) that may need to be implemented (by using the appropriate program logic) in each custom task in an embodiment of the present invention. Only a few Java-methods are shown for illustration, however, more number of methods could be defined as needed.

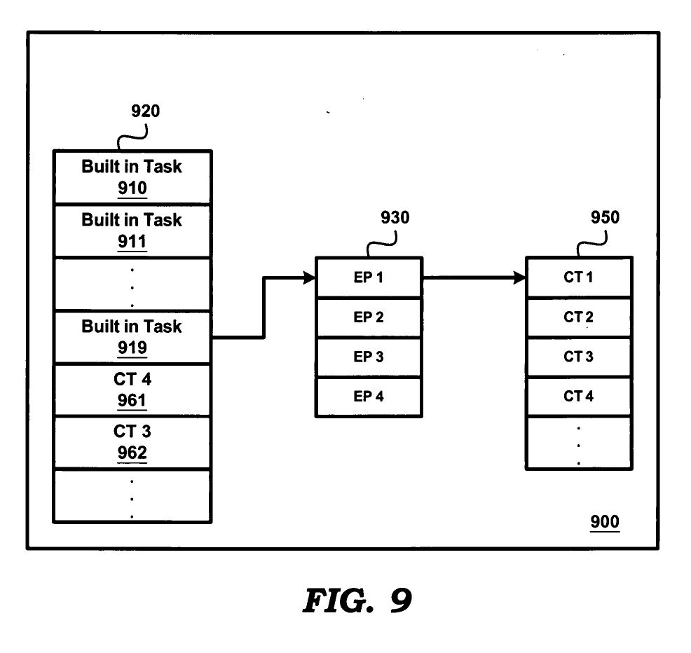

The Java-methods shown in lines 710-760 are invoked by work-flow manager 540 at a corresponding appropriate time/event. The Java-method getExtensionPoint( ) of line 760 needs to be implemented such that, when executed, the Java-method will provide all the extension points available in the custom task. The received information may be used, for example, by user interface module 530 to enable a user to customize work-flows as described below with reference to FIG. 9.

Continuing with reference to FIG. 7, initialize( ) Java-method in line 710 may be executed when initializing the corresponding custom task. Similarly, execute( ) (line 720), stop( ) (line 730), resume( ) (line 740), and suspend( ) (line 750) correspond to situations in which the task is to be executed, stopped (i.e., termination), resumed (i.e., after suspending), and suspended (when a custom task corresponding to an extension point is to be executed).

In general, each of the Java-methods of lines 710-750 may contain an extension point at any desired point as well (possibly provided by designer of meta directory server 150), and a desired custom task may be defined by a user associated with each extension point. The description is continued with reference to various program interfaces that may need to be provided within other modules.

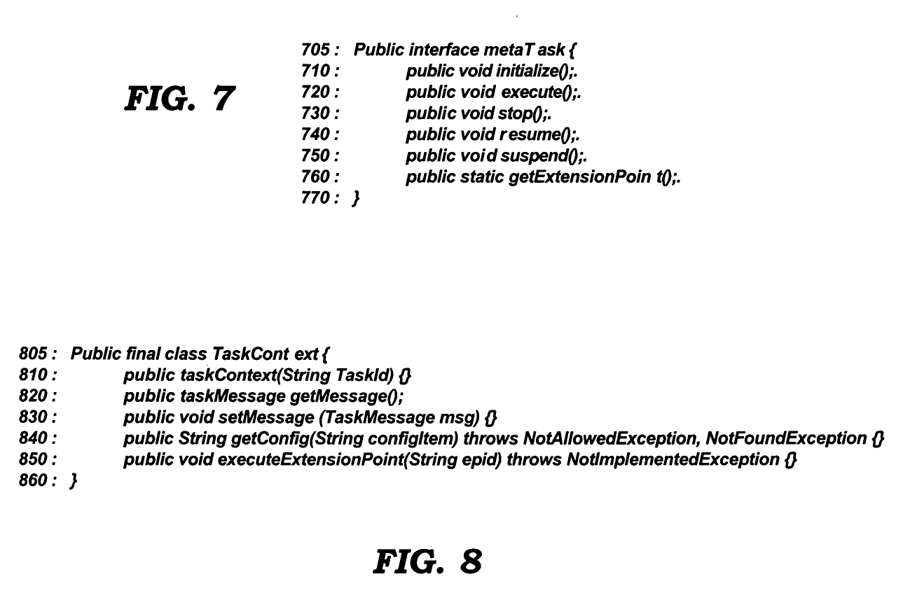

FIG. 8 contains declarations of Java-methods which may be required for custom tasks to interface with other modules of meta directory server 150 in an embodiment of the present invention. The program logic corresponding to the Java-methods may be used to restrict the access of custom tasks to message bus interface, core meta, etc. The implementation of the Java-methods (or similar utilities/interfaces) generally depends on the specific environment (e.g., hardware/software platform), and will be apparent to one skilled in the relevant arts by reading the disclosure provided herein.

Java-method taskContext( ) of line 810 enables (or need to enable) a custom task to receive the task identifier for itself (i.e., of the custom task). The Java-method getMessage( ) of line 820 enables a custom task to receive various input parameters (e.g., the record which caused the operation to be initiated or configuration data) into a variable taskMessage.

Similary, setMessage( ) utility of line 830 can be used to send (publish) any data (e.g., to store a record reflecting monitored information). The method getConfig in line 840 allows retrieval of configuration details in core meta module 570. As is well known, the keyword ‘throws’ is followed by exception conditions that may be generated, and the user may provide the corresponding handler programming logic.

The executeExtensionPoint( ) Java-method in line 850 enables the task to indicate to a work-flow manager that a particular extension point has been reached. The extension point may be identified by the corresponding extension point identifier. Work-flow manager 540 may access task registry block 510 to determine the custom task associated with the extension point, and execute the determined custom task. The description is continued with reference to an example user interface which enables a user to customize the work.

9. User Interface

FIG. 9 contains a display screen illustrating the manner in which a user may be provided the ability to customize a work flow. It is assumed that both the built-in tasks and custom tasks are registered in task registry block 510 before a customer seeks to customize a work flow. The display screen represents a situation in which part of the customization has already occured. The manner in which such a layout is generated, is described below in further detail.

Window 900 may initially display only portion 920 containing built-in tasks 910-919, which together represent the work flow sought to be customized. When a user selects one of the built-in tasks (e.g., 919, as shown), the extension points with the selected points may be displayed in pop-up menu 930. The extension points available in the task may be determined using getExtensionPoint( ) noted above in FIG. 7.

If a user selects one of the extension points (say EP1) in pop-up menu, the available custom tasks may be displayed in pop-up window 950. A user needs to select one of the custom tasks, for example CT1, in pop-up window 950 to indicate that custom task CT1 is to be executed when extension point EP1 is reached in built-in task 919.

The selected custom tasks may be displayed in portion 920 (as illustrated with reference to 961 and 962, which respectively contain CT4 and CT3). Using the approach above, a user may specify custom tasks associated with CT3 and CT4 as well to enable execution of a sequence of custom tasks.

In addition, the user may be required to specify whether each custom task is to be executed synchronously or asynchronously. The corresponding entry in task registry block 510 may be set such that the task is executed accordingly when the corresponding extension point is reached. Thus, the user interface enables a user to customize work flows.

It should be understood that different components of meta directory server 150 (and any system enabling an administrator to customize work-flows) can be implemented in a combination of one or more of hardware, software and firmware. In general, when throughput performance is of primary consideration, the implementation is performed more in hardware (e.g., in the form of an application specific integrated circuit).

When cost is of primary consideration, the implementation is performed more in software (e.g., using a processor executing instructions provided in software/firmware). Cost and performance can be balanced by implementing devices with a desired mix of hardware, software and/or firmware. Embodiments implemented substantially in the form of software are described below.

10. Software Implementation

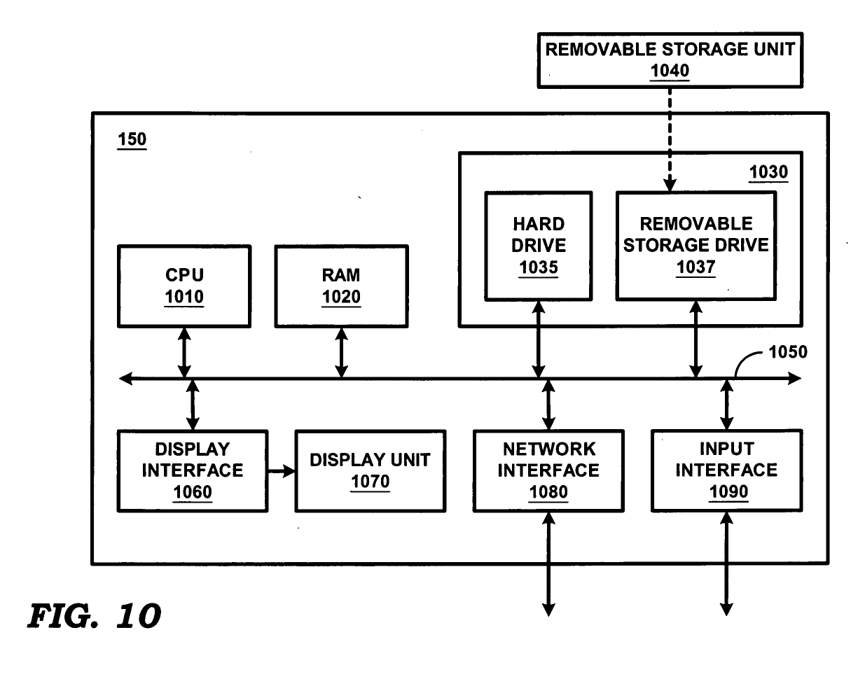

FIG. 10 is a block diagram illustrating the details of meta directory server 150 in one embodiment. Meta directory server 150 may correspond to any digital processing system, which enables an administrator to customize work-flows. Meta directory server 150 is shown containing processing unit (CPU) 1010, random access memory (RAM) 1020, secondary storage 1030, display interface 1060, display unit 1070, network interface 1080 and input interface 1090. Each block is described in further detail below.

Display interface 1060 provides output signals to display unit 1070, which can form the basis for a suitable interface for an administrator to interact with meta directory server 150. For example, the signals sent by display interface 1060 may form the basis for generating displays to monitor various transactions (e.g., update requests received/pending) and generate graphs/reports using custom tasks, while the built-in tasks continue to perform the transactions in asynchronous mode.

Input interface 1090 (e.g., interface with a key-board and/or mouse, not shown) enables a user/administrator to provide any necessary inputs to meta directory server 150. For example, the details of specific custom task to be executed associated with an extension point may be provided using input interface 1090.

Network interface 1080 may enable meta directory server 150 to send and receive data on communication networks using protocols such as IP. While network interface 1080 is shown as a single unit for conciseness, it should be understood that network interface may contain multiple units, with each unit potentially implemented using a different protocol.

RAM 1020 and secondary storage 1030 respectively provide volatile (but of low access times) and non-volatile memories. RAM 1020 receives instructions and data on path 1050 from secondary storage 1030, and provides the instructions to processing unit 1010 for execution. Secondary storage 1030 may contain units such as hard drive 1035 and removable storage drive 1037. Secondary storage 1030 may store the software instructions and data (e.g., task registry 410, noted above), which enable meta directory server 150 to provide several features in accordance with the present invention.

While secondary storage 1030 is shown contained within meta directory server 150, an alternative embodiment may be implemented with the secondary storage implemented external to meta directory server 150, and the software instructions (described below) may be provided using network interface 1080.

Some or all of the data and instructions may be provided on removable storage unit 1040 (or from a network using protocols such as Internet Protocol), and the data and instructions may be read and provided by removable storage drive 1037 to processing unit 1010. Floppy drive, magnetic tape drive, CD-ROM drive, DVD Drive, Flash memory, removable memory chip (PCMCIA Card, EPROM) are examples of such removable storage drive 1037.

Processing unit 1010 may contain one or more processors. Some of the processors can be general-purpose processors, which execute instructions provided from RAM 1020. Some can be special purpose processors adapted for specific tasks (e.g., for memory/queue management). The special purpose processors may also be provided instructions from RAM 1020.

In general, processing unit 1010 reads sequences of instructions from various types of memory medium (including RAM 1020, secondary storage 1030 and removable storage unit 1040), and executes the instructions to provide various features of the present invention. Thus, the embodiment(s) of FIG. 10 can be used to provide several features according to the present invention.

### 11. CONCLUSION

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A method of enabling a user to customize a work flow associated with an operation in a meta directory server, said operation requiring communication with at least two data sources, said method comprising:
providing a plurality of built-in tasks to implement said operation requiring communication with said two data sources, at least one of said plurality of built-in tasks containing an extension point;
receiving from said user data indicating a custom task associated with said extension point; and
executing said custom task when said extension point is reached during execution of said one of said plurality of built-in tasks.

2. The method of claim 1, wherein said plurality of built-in tasks are provided by a designer implementing said meta directory server, wherein said designer is different from said user.

3. The method of claim 1, wherein said custom task contains an another extension point, said method further comprises receiving from said user data indicating an another custom task to be executed when said another extension point is reached during execution of said custom task.

4. The method of claim 3, further comprising:
determining a corresponding set of extension points available in each of said plurality of built-in tasks;
displaying each of said set of extension points associated with a corresponding one of said plurality of built-in tasks;
displaying said custom task and said another custom task; and
enabling said user to specify said custom task associated with said extension point, and said another custom task associated with said another extension point.

5. The method of claim 3, further comprising enabling said user to specify that said custom task is to be executed synchronously, wherein said custom task is executed in a synchronous manner.

6. The method of claim 3, further comprising enabling said user to specify that said custom task is to be executed asynchronously, wherein said custom task is executed in a asynchronous manner.

7. The method of claim 3, wherein said operation comprises either a synchronization operation or a consolidation operation such that said plurality of built-in tasks implement either said synchronization operation or said consolidation operation.

8. The method of claim 7, wherein at least one of said two data sources comprises a relational database.

9. The method of claim 3, further comprising providing an utility to indicate that a specific one of said extension points is reached.

10. The method of claim 3, further comprising providing an utility in each of said plurality of built-in tasks and said custom task, wherein said utility indicates extension points available in a corresponding task.

11. A computer readable medium carrying one or more sequences of instructions for causing a meta directory server to enable a user to customize a work flow associated with an operation, said operation requiring communication with at least two data sources, wherein execution of said one or more sequences of instructions by one or more processors contained in said meta directory server causes said one or more processors to perform the actions of:
providing a plurality of built-in tasks to implement said operation requiring communication with said two data sources, at least one of said plurality of built-in tasks containing an extension point;
receiving from said user data indicating a custom task associated with said extension point; and
executing said custom task when said extension point is reached during execution of said one of said plurality of built-in tasks.

12. The meta directory server of claim 11, wherein said plurality of built-in tasks are provided by a designer implementing said meta directory server, wherein said designer is different from said user.

13. The meta directory server of claim 11, wherein said custom task contains an another extension point, further comprises receiving from said user data indicating an another custom task to be executed when said another extension point is reached during execution of said custom task.

14. The meta directory server of claim 13, further comprising:
determining a corresponding set of extension points available in each of said plurality of built-in tasks;
displaying each of said set of extension points associated with a corresponding one of said plurality of built-in tasks;
displaying said custom task and said another custom task; and
enabling said user to specify said custom task associated with said extension point, and said another custom task associated with said another extension point.

15. The meta directory server of claim 13, further comprising enabling said user to specify that said custom task is to be executed synchronously, wherein said custom task is executed in a synchronous manner.

16. The meta directory server of claim 13, further comprising enabling said user to specify that said custom task is to be executed asynchronously, wherein said custom task is executed in a asynchronous manner.

17. The meta directory server of claim 13, wherein said operation comprises either a synchronization operation or a consolidation operation such that said plurality of built-in tasks implement either said synchronization operation or said consolidation operation.

18. The meta directory server of claim 17, wherein at least one of said two data sources comprises a relational database.

19. The meta directory server of claim 13, further comprising providing an utility to indicate that a specific one of said extension points is reached.

20. The meta directory server of claim 13, further comprising providing an utility in each of said plurality of built-in tasks and said custom task, wherein said utility indicates extension points available in a corresponding task.

21. A meta directory server enabling a user to customize a work flow associated with an operation, said operation requiring communication with at least two data sources, said meta directory server comprising:
means for providing a plurality of built-in tasks to implement said operation requiring communication with said two data sources, at least one of said plurality of built-in tasks containing an extension point;
means for receiving from said user data indicating a custom task associated with said extension point; and
means for executing said custom task when said extension point is reached during execution of said one of said plurality of built-in tasks.

22. The meta directory server of claim 21, wherein said plurality of built-in tasks are provided by a designer implementing said meta directory server, wherein said designer is different from said user.

23. The meta directory server of claim 21, wherein said custom task contains an another extension point, further comprises means for receiving from said user data indicating an another custom task to be executed when said another extension point is reached during execution of said custom task.

24. The meta directory server of claim 23, further comprising:
means for determining a corresponding set of extension points available in each of said plurality of built-in tasks;
means for displaying each of said set of extension points associated with a corresponding one of said plurality of built-in tasks;
means for displaying said custom task and said another custom task; and
means for enabling said user to specify said custom task associated with said extension point, and said another custom task associated with said another extension point.

25. The meta directory server of claim 23, further comprising means for enabling said user to specify that said custom task is to be executed synchronously, wherein said custom task is executed in a synchronous manner.

26. The meta directory server of claim 23, further comprising means for enabling said user to specify that said custom task is to be executed asynchronously, wherein said custom task is executed in a asynchronous manner.

27. The meta directory server of claim 23, wherein said operation comprises either a synchronization operation or a consolidation operation such that said plurality of built-in tasks implement either said synchronization operation or said consolidation operation.

28. The meta directory server of claim 27, wherein at least one of said two data sources comprises a relational database.

29. The meta directory server of claim 23, further comprising an utility means to indicate that a specific one of said extension points is reached.

30. The meta directory server of claim 23, further comprising an utility means in each of said plurality of built-in tasks and said custom task, wherein said utility means indicates extension points available in a corresponding task.

31. A meta directory server enabling a user to customize a work flow associated with an operation, said operation requiring communication with at least two data sources, said meta directory server comprising:
a task registry block storing data related to a plurality of built-in tasks to implement said operation requiring communication with said two data sources, at least one of said plurality of built-in tasks containing an extension point;
a user interface module receiving from said user, data indicating a custom task associated with said extension point; and
work-flow manager module for executing said custom task when said extension point is reached during execution of said one of said plurality of built-in tasks.

32. The meta directory server of claim 31, wherein said plurality of built-in tasks are provided by a designer implementing said meta directory server, wherein said designer is different from said user.

33. The meta directory server of claim 31, wherein said custom task contains an another extension point, wherein said user interface further receives data indicating an another custom task to be executed when said another extension point is reached during execution of said custom task.

34. The meta directory server of claim 33, wherein said user interface modules displays each of said set of extension points associated with a corresponding one of said plurality of built-in tasks, and enables said user to specify said custom task associated with said extension point and said another custom task associated with said another extension point.

35. The meta directory server of claim 33, wherein said user interface enables said user to specify that said custom task is to be executed synchronously, wherein said custom task is executed in a synchronous manner.

36. The meta directory server of claim 33, wherein said user interface enables said user to specify that said custom task is to be executed asynchronously, wherein said custom task is executed in a asynchronous manner.
